(19) United States
(12) Patent Application Publication
(10) Pub. No.: US 2003/0108295 A1
(43) Pub. Date: Jun. 12, 2003

(54) Optical funnel

(76) Inventor: Guanghua Huang, Prior Lake, MN (US)

Correspondence Address: MERCHANT & GOULD PC, P.O. BOX 2903, MINNEAPOLIS, MN, 55402-0903, US

(21) Appl. No.: 10/014,073

(22) Filed: Dec. 10, 2001

(51) Int. Cl. G02B 6/26

(52) U.S. Cl. 385/43; 385/31

(57) ABSTRACT

An apparatus for directing light into the end of an optical fiber. The apparatus comprises a funnel member having an axis and an endless wall. At least a portion of the endless wall has a conical shape and an interior surface defining an interior volume. The funnel member has a first end having a cross-sectional area and a second end having a cross-sectional area. The cross sectional area of the first end is larger than the cross-sectional area of the second end. A collar is proximal to the second end of the funnel member. A coating covers at least a portion of the interior surface and forms a light reflective surface. The reflective surface faces at least a portion of the interior volume. At least a portion of the sidewall has an angle relative to the axis.

### TECHNICAL FIELD

The present invention relates to optics, and more specifically to an optical funnel for directing light into the end of an optical fiber.

### BACKGROUND

Technology for computers and telecommunications have developed and improved significantly since they were initially developed. One area of this improvement is signal transmission path, which is the medium for transferring information signals. In the past, metallic conductors such as copper wires were used to transfer information in the form of electricity. However, conductors over which the information can be transferred have many limitations including speed, bandwidth (or signal capacity), distance, and distortion.

Fiber optics, which uses light carried by an optical fiber, improves all four of these characteristics. They can transfer more information, they can transfer it faster and at greater distances, and they can transfer it with less distortion. Other advantages of fiber include increased security over metallic conductors and a smaller diameter than metallic cabling such as copper wires.

Despite these advantages, fiber optics is not without its own limitations. For example, fiber optics requires a light source to inject light pulses into one end of the fiber. This light must enter the tip or end of the fiber within a certain angle of the fiber's axis called the acceptance angle to ensure that there is total internal transmission within the core of the optical fiber. Because of the small diameter of optical fibers, the tolerance is very small and very critical. A misalignment between the end of the optical fiber and the light source can cause a host of problems such as insertion loss, which results when only a portion of the light entering into the fiber. Insertion loss can cause performance degradation such as reducing the distance that the light can propagate through the fiber.

There are a variety of techniques, including passive and active techniques, for aligning the output of a light source with the end of an optical fiber. An example of a passive technique includes a high-precision connector that provides submicron alignment between the fiber tip and the light source. These passive systems require very precisely machined parts that are expensive to manufacture. There is very little margin of error and the slightest fault in the connector, the optical fiber, or the light source can result in misalignment and a high insertion loss.

An example of an active technique is a micro electrical mechanical system (MEMS) device or other device that moves the fiber tip to align the end of the optical fiber with the light source. An example of a MEMS device for aligning the end of a fiber is The Boeing Company's in-package micro-aligner. In such a system, the amount of light that propagates through the optical fiber is measured and a microprocessor causes the MEMS device to move the fiber tip until the amount of propagated light is maximized and hence the end of the fiber is aligned with the light source. Such active systems are also expensive, require precise equipment to move the fiber in submicron distances, require equipment for measuring the amount of light that is output at the distal end of the fiber, and require programmable equipment. Furthermore, such systems tend to be sensitive to environmental stress, which may adversely affect the precision of the equipment.

There are other passive and active techniques to align the end of an optical fiber with a light source. However, all of these devices attempt to align the very small cross-sectional area at the end of the optical fiber with the small output area of the light source. As a result, a great deal of precision is needed to maintain an alignment within a submicron degree of tolerance. Such devices and systems are difficult and expensive to manufacture. Additionally, the may be sensitive to physical stress such as a physical impact or temperature changes, which can misalign the fiber and the light source.

### SUMMARY

In general terms, the present invention is directed to an optical funnel. The optical funnel has a reflective surface and can be attached to the end of an optical fiber. The funnel receives light at a first end and guides the light to a second end and into the end of the optical fiber. The first end has a larger cross-sectional area than the second end. One advantage of the optical funnel is that it increases the total receiving area of the optical fiber. It provides greater tolerance for light sources that are not precisely aligned with the axis of the fiber. This advantage is especially useful for optical fibers that have a very small diameter.

One aspect of the present invention is an apparatus for directing light into the end of an optical fiber. The apparatus comprises a funnel member defines an interior volume and has a first end having a cross-sectional area and a second end having a cross-sectional area. The cross sectional area of the first end is larger than the cross-sectional area of the second end. A reflective surface faces at least a portion of the interior volume.

Another aspect of the present invention is a method of directing light into an end of an optical fiber, using a funnel member having a first end, a second end, an interior volume, and a reflective surface. The method comprises receiving ray of light at the first end of the funnel member; reflecting the ray of light against the reflective surface; passing the ray of light through the second end of the funnel member; and passing the ray of light into the end of the optical fiber.

Yet another aspect of the present invention is directed to a method of assembling an optical fiber apparatus. The method comprises providing an optical fiber having an end; providing a funnel member defining an interior volume and having a first end having a cross-sectional area, and a second end having a cross-sectional area, the cross sectional area of the first end being larger than the cross-sectional area of the second end; and positioning the funnel member so that the end of the optical fiber is opposing the second end of the funnel member.

Another aspect of the present invention is an apparatus comprising a funnel member having an axis and an endless wall. At least a portion of the endless wall has a conical shape and an interior surface defining an interior volume. The funnel member has a first end having a cross-sectional area and a second end having a cross-sectional area. The cross sectional area of the first end is larger than the cross-sectional area of the second end. A collar is proximal to the second end of the funnel member. A coating covers at least a portion of the interior surface and forms a reflective surface. The reflective surface faces at least a portion of the interior volume. At least a portion of the sidewall has an angle relative to the axis in the range of about 15° and about 30°. The first end is substantially circular, is substantially orthogonal to the axis, and has a first inner diameter (d₁). The second end is substantially circular, is substantially orthogonal to the axis, and has a second inner diameter (d₂), and the ratio (d₁/d₂) of the first diameter to the second diameter is in the range of about 1 and about 10.

Another aspect of the present invention is a method of directing light into an end of an optical fiber using a funnel member. The method comprises: receiving ray of light through a first end of the funnel member, the first end having a cross sectional area in the range of about 3 μm² and about 2000 μm²; passing the ray of light through a void defined by an interior surface of the funnel member, the interior surface having an angle relative to an axis of the funnel member in the range of about 15° and about 30°; reflecting the ray of light against a reflective surface covering at least a portion of the interior surface; passing the ray of light through a second end of the funnel member, the second end having a cross-sectional area in the range of about 0.2 μm² and about_{—}79 μm²; passing the ray of light into a cavity defined proximal to the end of the optical fiber; and directing the ray of light onto a path within the optical fiber, the path being parallel to an axis of the optical fiber.

### DESCRIPTION OF THE DRAWINGS

FIG. 1A is a cross-sectional view of an optical funnel embodying the present invention.

FIG. 1B is an end view of the optical funnel illustrated in FIG. 1A.

FIG. 2A is a cross-sectional view of an alternative embodiment of an optical funnel embodying the present invention.

FIG. 2B is an end view of the optical funnel illustrated in FIG. 2A.

FIG. 3 is a cross-sectional view of an alternative embodiment of an optical funnel embodying the present invention.

FIG. 4 is a cross sectional view of the optical funnel illustrated in FIGS. 1A and 1B together with an optical fiber.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

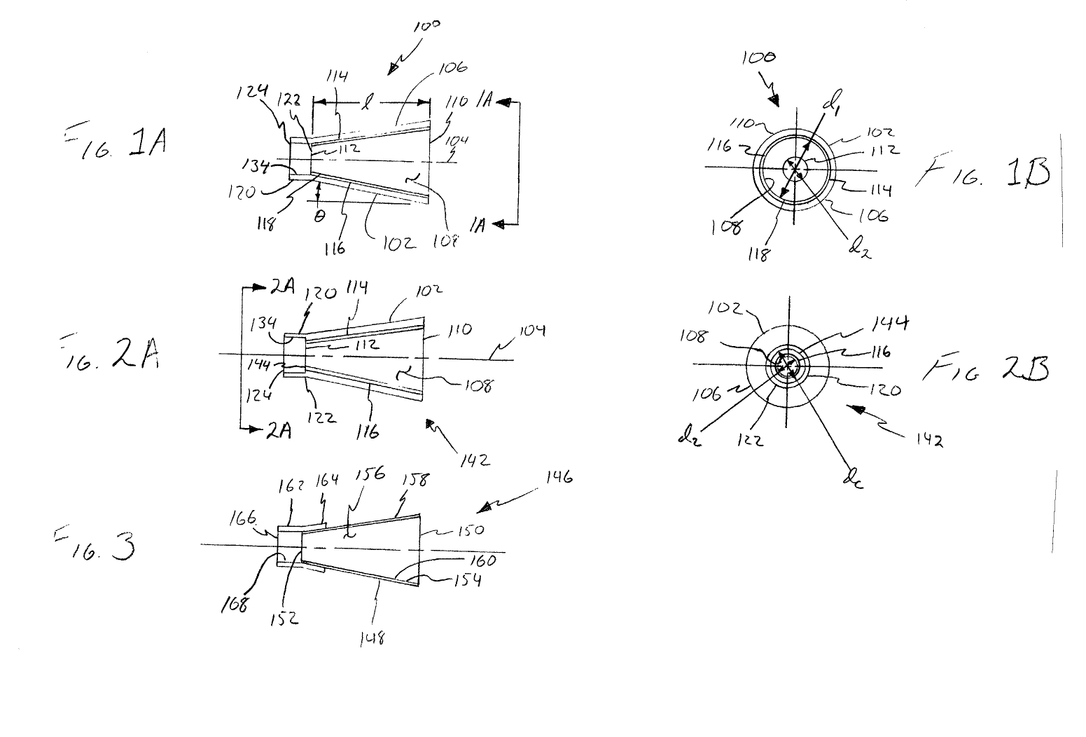

FIGS. 1A and 1B illustrate one possible embodiment of an optical funnel, generally shown as 100. A funnel member 102 has an axis 104 and an endless wall 106 that is symmetrically disposed around the axis 104. The endless wall 106 defines an interior volume 108. A first end 110 is circular and has a cross-sectional area that is planar and is orthogonal to the axis 104. A second end 112 is oppositely disposed from the first end 110, is circular, and is planar and orthogonal to the axis 104. In this possible configuration, the funnel member 102 is conical and the cross-sectional area of the first end 110 is larger than the cross-sectional area of the second end 112.

The endless wall 106 has an interior surface 114 that is reflective and defines a void, which forms the interior volume 108. In one possible embodiment, a light reflective material 116 is applied to the interior surface 114 by coating the reflective material 116 on the interior surface 114. The reflective material 116 forms a reflective surface 118 that faces the interior volume 108 or void. The reflective material 116 can be applied to the interior surface 114 using any appropriate techniques such as deposition, plating, or any other technique to causes the reflective material 116 to adhere to the interior surface 114. In another possible embodiment, the interior surface 114 of the endless wall 106 is polished to form a reflective surface.

The funnel member 102 can have many possible combinations of dimensions. In one possible embodiment, for example, length (l) of the funnel member 102 is in the range of about 1 μm and about 50 μm, and the angle (θ) of the endless wall 106, relative to the axis is about 75° or less. The inner diameter (d₁) of the first end 110 is in the range of about 2 μm and about 50 μm, which provides a cross-sectional area in the range of about 3 μm² and about 2000 μm². The inner diameter (d₂) of the second end 112 is in the range of about 0.5 μm and about 10 μm, which provides a cross-sectional area in the range of about 0.2 μm² and about 79 μm². The inner diameter is the diameter measured to the reflective surface 118. The ratio (d₁/d₂) of the inner diameters of the first end 110 to the inner diameter of the second end 112 is in the range of about 1 to about 10. In yet another possible embodiment, the angle (θ) of the endless wall 106 is in the range of about 15° and about 30°.

A collar 120 has first end and second ends 122 and 124, and is connected to the funnel member 102 at the second end 112. In one possible embodiment, the collar 120 is integrally formed with the endless wall 106 and the first end 122 of the collar 120 forms the second end 112 of the funnel member 102.

An optical fiber 126 has a core 127, a cladding 129, and an end 128 that is inserted into the collar 120 and positioned adjacent to the second end 112 of the funnel member 102. A cavity 130 is formed in the end 128 of the optical fiber 126. In one possible embodiment, the cavity 130 is open to the end 128 of the optical fiber 126 and has a semispherical surface 132 such that substantially all points in the surface 132 are equidistant from a common center point. Other embodiments have different shapes and configurations of the cavity 130, different angles of slopes that form the surface 132 of the cavity 130, or have the cavity 130 filled with a material that is different than the material that forms the core of the optical fiber 126. If the cavity 130 is filled, the index of refraction for the material that fills the cavity 130 is less than the index of refraction for the material that forms the core 127 of the optical fiber 126. Other possible embodiments do not include any cavity formed in the end 128 of the optical fiber 126 at all.

Cladding 129 of the optical fiber is removed from the portion of the optical fiber 126 that is inserted into the collar 120. The optical fiber 126 is held in the collar 120 by an adhesive of epoxy that is applied between the outer surface of the core 127 and the inner surface 134 of the collar 120. Alternatively, the core 127 can be positioned within the collar 120 without removing the cladding 129 and/or without any adhesive or epoxy. One embodiment might use frictional forces between the core 127 and the inner surface of the collar 120 to hold the fiber core 127 in place. In yet another embodiment, the optical funnel 100 is made and used without a collar. In such an embodiment, for example, an external clamp or bracket may be used to grip the optical fiber 126 near the end 128 and hold the optical fiber 126 in place.

Additionally, the optical funnel 100 can interface with any size of optical fiber, as well as either a single-mode optical fiber or a multi-mode optical fiber. In one possible embodiment, however, the optical fiber 126 is a single-mode fiber and has a diameter in the range of about 0.5 μm and about maximum up to 10 μm.

In use, referring to FIG. 4, a light source 136 such as a laser is positioned adjacent to and facing the first end 110 of the funnel member 102. The light source 136 emits light 138, which passes through the first end 110 and into the interior volume 108 of the funnel member 102. Light 138 that is not axially aligned with the optical fiber 126 or not otherwise directed directly into the end 128 of the optical fiber 126 will reflect off the reflective surface 118 of the funnel member 102. The reflected light 140 travels into the cavity 130 formed in the end 128 of the fiber 126 and then enters into the optical fiber 126 . As the light crosses the surface 132 of the cavity 130, it bends and is directed onto a path that is substantially parallel to the axis 141 of the fiber 126.

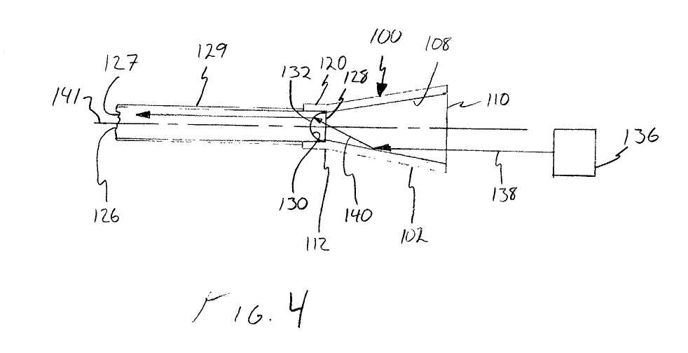

Referring to FIGS. 2A and 2B, an alternative embodiment of the optical funnel, which is generally illustrated as 142. Optical funnel 142 is substantially similar to the optical funnel 100 and includes a funnel member 102 having a first end 110, a second end 112, an interior volume 108, an interior surface 114 coated with a light reflective material 116, and a collar 120. The inner diameter (d_{c}) of the collar 120 is larger than the inner diameter of the second end 112 of the funnel member 102, which forms a shoulder 144 that faces the collar 120. The shoulder 144 functions as a stop to enable proper location of the end 128 of the fiber 126 relative to the second end 112 of the funnel member 102.

FIG. 3 illustrates another alternative embodiment of an optical funnel generally shown as 146. A funnel member 148 is formed with a material that is translucent so that light travel through the body of the funnel member 148. The funnel member 148 has a first end 150 and a second end 152. The funnel member 148 also has a sidewall 154 that defines an interior volume 156. A light reflective coating 158 covers the sidewall 154 forming a reflective surface 160 that faces the interior volume 156. A collar 162 has a first end 164 and a second end 166. The collar 162 is generally tubular and defines an inner passage 168. The second end 152 of the funnel member 148 is inserted into the second end 166 of the collar 162 and extends into a portion of the collar's 162 inner passage 168.

In use, the end 128 of an optical fiber 126 is inserted into the first end 164 of the collar 162 until it is positioned against the second end 152 of the funnel member 148. In other embodiments, there is a space or gap between the end 128 of the fiber 126 and the second end 152 of the funnel member 148. The optical funnel 146 directs light in a manner similar to the optical funnel 100, which was described above with reference to FIG. 4. When light enters the first end 150 of the funnel member 148, it travels through the interior volume 156 and reflects off the reflective surface 160 of the material 158 that is applied to the sidewall 154 of the funnel member 148. The reflected light then travels through the second end 152 of the funnel member 148 and into the end 128 of the optical fiber 126.

There are many possible alternatives to the embodiments described herein. For example, the funnel member could have shapes other than conical. The first and second ends can have various shapes or configurations, and edges that define then first and second ends may not be planar or orthogonal to the axis. It is also conceivable that the optical funnel is not symmetrical around a single axis or even two axes that are parallel to one another. Furthermore, the funnel member and reflective surfaces can be made from any material and with any structure that conducts and reflects light, respectively. Additionally, the funnel member, collar, and optical fiber that is used with the funnel member and collar can be any size and have any dimension, although very small, single mode fibers are described above. In essence, the funnel member can have any shape or be made of any material that receives light at one end and directs the light to another, smaller end.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. An apparatus for directing light into the end of an optical fiber, the apparatus comprising:
a funnel member having an axis and an endless wall, at least a portion of the endless wall having a conical shape and an interior surface defining an interior volume, the funnel member further having a first end having a cross-sectional area and a second end having a cross-sectional area, the cross sectional area of the first end being larger than the cross-sectional area of the second end;
a collar proximal to the second end of the funnel member;
a coating covering at least a portion of the interior surface, the coating forming a light reflective surface, the reflective surface facing at least a portion of the interior volume; and
wherein at least a portion of the side wall has an angle relative to the axis in the range of about 15° and about 30°, the first end is substantially circular, is substantially orthogonal to the axis, and has a first inner diameter (d₁), the second end is substantially circular, is substantially orthogonal to the axis, and has a second inner diameter (d₂), and the ratio (d₁/d₂) of the first diameter to the second diameter is in the range of about 1 and about 10.

2. The apparatus of claim 1 further comprising a single mode optical fiber engaging the collar, the optical fiber having a diameter in the range from about 0.5 μm to about 10 μm.

3. A method of directing light into an end of an optical fiber using a funnel member, the method comprising:
receiving ray of light through a first end of the funnel member, the first end having a cross sectional area in the range of about 3 μm² and about 2000 μm²;
passing the ray of light through a void defined by an interior surface of the funnel member, the interior surface having an angle relative to an axis of the funnel member in the range of about 15° and about 30°;
reflecting the ray of light against a reflective surface covering at least a portion of the interior surface;
passing the ray of light through a second end of the funnel member, the second end having a cross-sectional area in the range of about 0.2 μm² and about 79 μm²;
passing the ray of light into a cavity defined proximal to the end of the optical fiber;
directing the ray of light onto a path within the optical fiber, the path being parallel to an axis of the optical fiber.

4. An apparatus for directing light into the end of an optical fiber, the apparatus comprising:
a funnel member defining an interior volume and having a first end having a cross-sectional area, and a second end having a cross-sectional area, the cross sectional area of the first end being larger than the cross-sectional area of the second end; and
a reflective surface facing at least a portion of the interior volume.

5. The apparatus of claim 4 wherein the funnel member includes an endless wall and the wall defines a void, and the void forms the interior volume.

6. The apparatus of claim 5 wherein at least a portion of the endless wall is generally conical.

7. The apparatus of claim 5 wherein the endless wall has an interior surface and the interior surface is polished to form the reflective surface.

8. The apparatus of claim 5 wherein the endless wall has an interior surface, and the reflective surface is formed by a coating of reflective material applied to the interior surface.

9. The apparatus of claim 4 wherein the funnel member includes a solid member formed with a translucent material, the solid member including an outer surface, and a coating of reflective material is applied to the solid member.

10. The apparatus of claim 9 wherein at least a portion of the solid member is generally conical.

11. The apparatus of claim 4 further comprising an optical fiber, the optical fiber having an end, the end being positioned adjacent to the second end of the funnel member.

12. The apparatus of claim 11 wherein the optical fiber has a diameter in the range from about 0.5 μm to about 10 μm.

13. The apparatus of claim 11 wherein the optical fiber is a single mode fiber.

14. The apparatus of claim 11 wherein the optical fiber defines a cavity proximal to the end of the optical fiber.

15. The apparatus of claim 14 wherein the cavity is open at the end of the optical fiber and is formed by a surface wherein substantially all points on the surface are substantially equidistance from a common center point.

16. The apparatus of claim 11 further comprising a collar attached to the funnel member, at least a portion of the optical fiber being positioned within the collar.

17. The apparatus of claim 4 wherein the funnel member includes an axis and a sidewall, at least a portion of the sidewall having an angle relative to the axis is in the range of about 15° and about 30°.

18. The apparatus of claim 17 wherein:
the first end is substantially circular, is substantially orthogonal to the axis, and has a first inner diameter (d₁);
the second end is substantially circular, is substantially orthogonal to the axis, and has a second inner diameter (d₂); and
the ratio (d₁/d₂) of the first diameter to the second diameter is in the range of about 1 and about 10.

19. The apparatus of claim 18 wherein the first end is substantially circular, is substantially orthogonal to the axis, and has an inner diameter in the range of about 2 μm and about 50 μm.

20. The apparatus of claim 18 wherein the second end is substantially circular, is substantially orthogonal to the axis, and has an inner diameter in the range of about 0.5 μm and about 10 μm.

21. The apparatus of claim 17 wherein the length of the axis between the first and second ends is in the range of about 1 μm and about 50 μm.

22. A method of directing light into an end of an optical fiber, using a funnel member having a first end, a second end, an interior volume, and a reflective surface, the method comprising:
receiving ray of light at the first end of the funnel member;
reflecting the ray of light against the reflective surface;
passing the ray of light through the second end of the funnel member; and
passing the ray of light into the end of the optical fiber.

23. The method of claim 22 wherein the optical fiber has an axis and passing the ray of light into the end of the optical fiber includes directing the optical fiber along a path within the optical fiber, the path being substantially parallel to the axis.

24. The method of claim 23 wherein the optical fiber defines a cavity, the cavity being open at the end of the optical fiber, and passing the ray of light into the end of the optical fiber further includes passing the ray of light through the cavity.

25. The method of claim 22 wherein the funnel member is generally conical in shape and defines a void, the method further comprising passing the ray of light through the void.

26. The method of claim 22 wherein the funnel member includes a solid member formed with a translucent material, the method further comprising passing the ray of light through the translucent material.

27. The method of claim 22 wherein:
the funnel has an axis, the first end is substantially circular and has a cross-sectional area substantially orthogonal to the axis, and the second end is substantially circular and has a cross-sectional area substantially orthogonal to the axis;
receiving the ray of light through the first end of the funnel member includes receiving the ray of light through a cross-sectional area in the range of about 3 μm² and about 2000 μm²; and
passing the ray of light through the second end of the funnel member includes passing the ray of light through a cross-sectional area in the range of about 0.2 μm² and about 79 μm².

28. The method of claim 27 further comprises reflecting the ray of light off a reflective surface having an angle relative to the axis of about 75° or less.

29. A method of assembling an optical fiber apparatus, the method comprising:
providing an optical fiber having an end;
providing a funnel member defining an interior volume and having a first end having a cross-sectional area, and a second end having a cross-sectional area, the cross sectional area of the first end being larger than the cross-sectional area of the second end; and
positioning the funnel member so that the end of the optical fiber is opposing the second end of the funnel member.

30. The method of claim 29 wherein a collar is attached to the funnel member and positioning the funnel member so that the end of the optical fiber is opposing the second end of the funnel member includes inserting the end of the fiber into the collar.

31. The method of claim 30 further comprising bonding the optical fiber to the collar.

32. The method of claim 31 wherein:
providing an optical fiber having an end includes providing a single mode optical fiber having a core and a cladding; and
bonding the optical fiber to the collar includes bonding the optical fiber to the cladding and not bonding the collar to the core.

33. The method of claim 29 wherein providing a funnel member defining an interior volume includes providing a funnel member having an endless wall, the wall having an inner surface, the method further comprising creating a reflective surface on the inner surface.

34. The method of claim 33 wherein creating a reflective surface includes polishing the inner surface of the endless wall.

35. The method of claim 33 wherein creating a reflective surface includes placing a reflective material over at least a portion of the inner surface.

36. The method of claim 29 wherein providing a funnel member defining an interior volume includes providing a solid funnel member formed with a translucent material, the solid funnel member having an exterior surface, the method further comprising creating a reflective surface on the exterior surface.

37. The method of claim 36 wherein creating a reflective surface includes placing a reflective material over at least a portion of the exterior surface.
